(19) United States
(12) Patent Application Publication
(10) Pub. No.: US 2012/0324875 A1
(43) Pub. Date: Dec. 27, 2012

(54) OPTIMIZED SYSTEM RESPONSE WITH MULTIPLE COMMANDS

(75) Inventors: BRAD EDLER, METAMORA, IL (US); VIRAL S. MEHTA, PEORIA, IL (US); CHRISTOPHER WILLIAMSON, GREENDALE, WI (US); JEFFREY KUEHN, GERMANTOWN HILLS, IL (US)

(73) Assignee: CATERPILLAR INC., PEORIA, IL (US)

(21) Appl. No.: 13/168,628

(22) Filed: Jun. 24, 2011

(51) Int. Cl. F15B 13/06; F15B 21/08

(52) U.S. Cl. 60/327; 60/484; 60/459

(57) ABSTRACT

A method and system for operating a machine having first and second movable elements, first and second hydromechanical movers for moving the first and second movable elements, respectively, and first and second hydraulic pumps linked to the first and second hydromechanical movers, respectively. Movement requests for moving the first and second movable elements are processed such that the movement command to the second hydromechanical mover is reduced by a variable amount based on the magnitude of the first movement request. For commanded first hydromechanical mover movements below a certain level, flow to the second hydromechanical mover may optionally not be reduced.

### TECHNICAL FIELD

This patent disclosure relates generally to excavators and other machines having a meterless hydraulic system capable of actuating multiple functions at a given time via hydromechanical movers, and, more particularly to arrangements for adapting such a system to provide a more user-friendly experience during high acceleration movement of one of the functions.

### BACKGROUND

Unlike a typical hydraulic system having a single hydraulic pump feeding a plurality of valves to control an associated plurality of hydraulic actuators and hydraulic motors (herein included in the term “hydromechanical movers”) for various functions, a “meterless” hydraulic control system controls one or more hydraulic actuators and/or motors associated with separate movements or functions by controlling a flow rate from a dedicated pump associated with those hydromechanical movers. Thus, while proportional or throttling valves are utilized in prior art metered systems to meter fluid to control movement of each hydromechanical mover, the flow to each hydromechanical mover in a meterless system is controlled directly by controlling the associated pump. The dedicated pump or pumps may be of any suitable type including variable displacement or fixed displacement, wherein the flow from the pump to the actuator chambers is varied in order to control the speed and extent of the movement.

In prior art meterless arrangements, pump controlled circuits known as Displacement Controls (DC) utilize a variable displacement pump with a constant speed driver, while Electro-Hydrostatic Actuators (EHA) utilize a fixed displacement pump with a variable speed driver. In either case, the system is able to move multiple functions simultaneously more efficiently than prior systems. Although this is generally a substantial benefit, the response that the operator experiences from the machine in certain circumstances is sometimes unsettling for operators accustomed to more traditional equipment.

For example, in an excavator having a traditional hydraulic system, when an operator “comes out of the hole” by commanding swing at the same time as commanding the boom up sharply, the swing pump and associated motor speed response is naturally sluggish due to the simultaneous hydraulic requirements of the boom actuator(s). In comparison, a meterless system is able to fully supply both functions, with the result that the swing movement may occur much more vigorously than the operator had anticipated based on his or her experience with traditional metered systems. This may lead to operator surprise or discomfort.

It will be appreciated that this background section sets forth a collection of concepts that the inventors considered in their contemplations regarding the invention. This background section does not, however, purport to be or to describe prior art except as expressly noted. Rather, it describes certain inventor observations and ideas based on those observations.

### SUMMARY

In one aspect of the disclosure, there is described a machine having meterless hydraulic actuation of a plurality of functions, the machine having a first movable element, a first hydromechanical mover for moving the first movable element, and a first hydraulic pump linked to the first hydromechanical mover to supply hydraulic fluid thereto and receive hydraulic fluid therefrom. A second movable element is included as well as a second hydromechanical mover for moving the second movable element, and a second hydraulic pump, distinct from the first hydraulic pump, linked to the second hydromechanical mover to supply hydraulic fluid thereto and receive hydraulic fluid therefrom.

A user interface for receiving movement requests for moving the first and second movable elements is included in the machine, as is a controller for generating movement commands to the first and second hydromechanical movers based on the received first and second movement requests. The movement command to the second hydromechanical mover is reduced by a variable amount based on the magnitude of the first movement request.

In another embodiment, a method is described for adjusting movement of movable elements in a machine having meterless hydraulic actuation of a plurality of functions. The method includes receiving a first movement request for movement of a first machine element, the first machine element being actuated by a first hydromechanical mover having a first hydraulic pump linked to the first hydromechanical mover to supply hydraulic fluid thereto and receive hydraulic fluid therefrom. The method further includes receiving contemporaneously with the first movement request a second movement request for movement of a second machine element, the second machine element being actuated by a second hydromechanical mover having a second hydraulic pump, distinct from the first hydraulic pump, to supply hydraulic fluid thereto and receive hydraulic fluid therefrom. Movement commands are generated for the first and second hydromechanical movers based on the received first and second movement requests, wherein generating the second movement command includes applying to the second request a variable rate based on the magnitude of the first movement request.

In yet another embodiment, a controller for controlling first and second hydromechanical movers linked to first and second movable elements in a machine is described. Each hydromechanical mover includes a separate respective hydraulic pump for supplying pressurized hydraulic fluid to, and receiving pressurized hydraulic fluid from, the hydromechanical mover. The controller includes a computer-readable memory having thereon computer-executable instructions including instructions for receiving a first movement request for movement of the first movable element, receiving contemporaneously with the first movement request a second movement request for movement of the second movable element, and generating movement commands to the first and second hydromechanical movers based on the received first and second movement requests. Generating the second movement command includes applying to the second request a variable rate based on the magnitude of the first movement request.

Other features and advantages of the described principles will be apparent from the detailed specification, taken in conjunction with the attached drawing figures, of which:

### BRIEF DESCRIPTION OF THE DRAWINGS

FIG. 1 is a side elevational view of a machine incorporating aspects of this disclosure;

FIG. 2 is a schematic view of a hydraulic system according to this disclosure including a hydraulic circuit, including actuators, motors, pumps and pressure transducers;

FIG. 3 is a schematic control architecture view of the pump displacement control of FIG. 2 including data and command signaling;

FIG. 4 is a simplified plot showing boom circuit flow and a correlated swing circuit flow limit according to an embodiment of the disclosure; and

FIG. 5 is a flow chart of a process for establishing a swing circuit flow based on a boom circuit flow to replicate a behavior of a metered hydraulic system according to an embodiment of the disclosed system and method.

### DETAILED DESCRIPTION

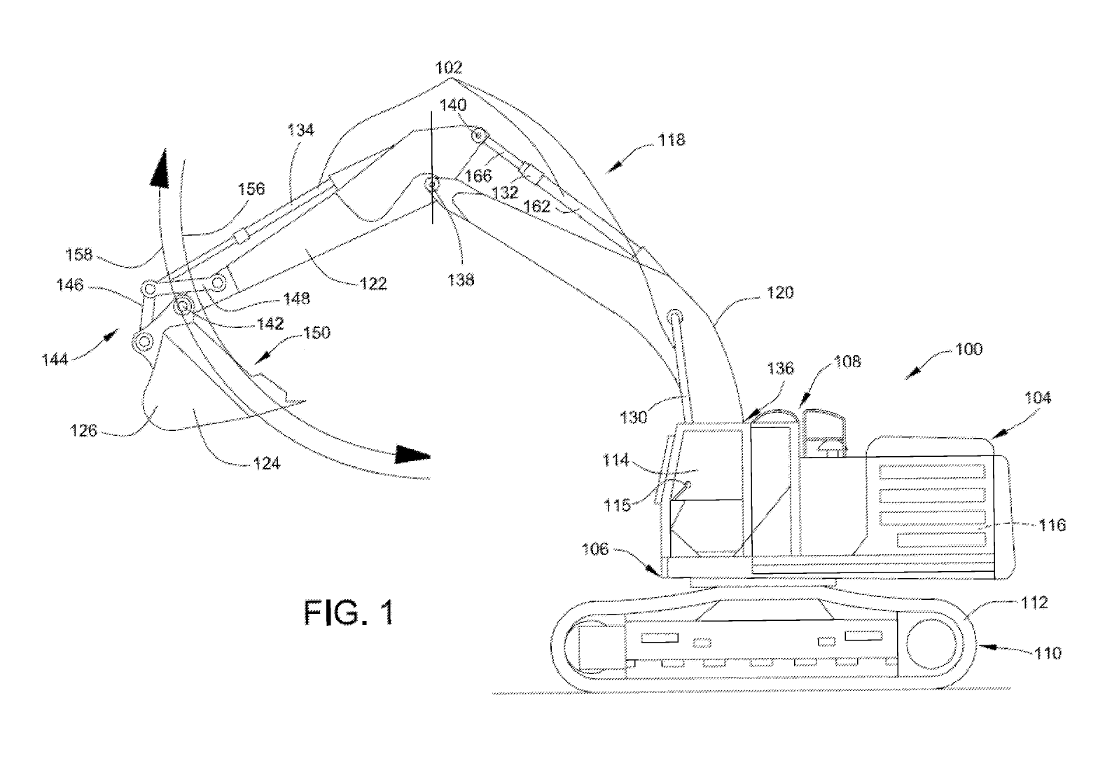

This disclosure relates to machines 100 that utilize hydromechanical movers (identified generally as 102) to control movement of moveable subassemblies of the machine, such as arms, booms, implements, or the like, as well as rotation of the assemblies of the machine 100. For the purposes of this disclosure and the appended claims, the term “hydromechanical movers” will be used to refer to both actuators and motors that are hydraulically operated by a pump. More specifically, the disclosure relates to such so-called meterless hydraulic systems 104 utilized in machines 100, such as the excavator 106 illustrated in FIG. 1, used to control rotation or extension and retraction of such hydromechanical movers 102. While the arrangement is illustrated in connection with an excavator 106, the arrangement disclosed herein has universal applicability in various other types of machines 100 as well. The term “machine” may refer to any machine that performs some type of operation associated with an industry such as mining, construction, farming, transportation, or any other industry known in the art. For example, the machine may be a wheel loader or a skid steer loader. Moreover, one or more implements may be connected to the machine 100. Such implements may be utilized for a variety of tasks, including, for example, brushing, compacting, grading, lifting, loading, plowing, ripping, and include, for example, augers, blades, breakers/hammers, brushes, buckets, compactors, cutters, forked lifting devices, grader bits and end bits, grapples, blades, rippers, scarifiers, shears, snow plows, snow wings, and others.

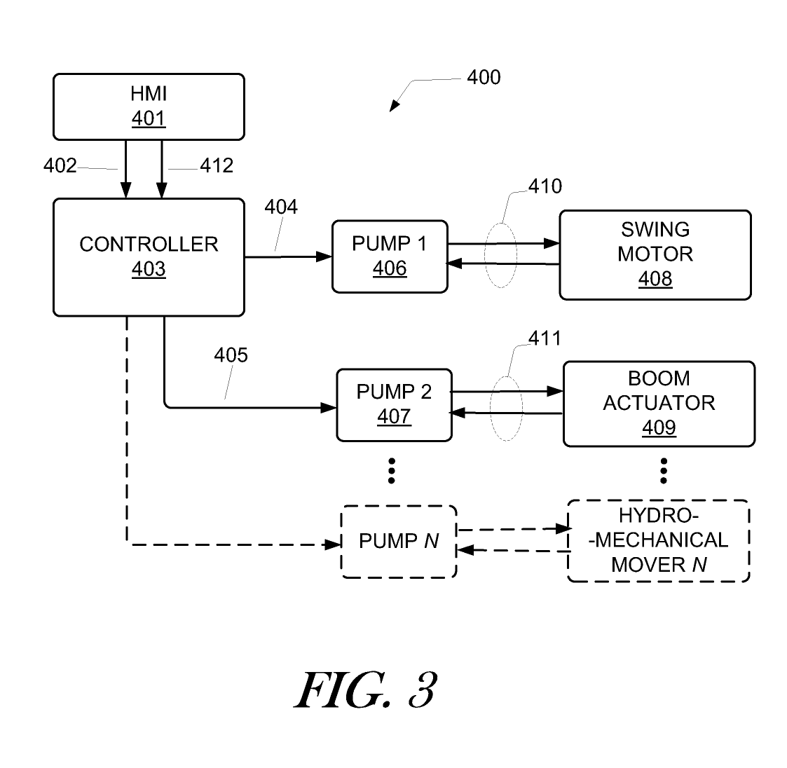

The excavator 106 of FIG. 1 includes a cab 108 that is swingably supported on an undercarriage 110 that includes a pair of rotatably mounted tracks 112. The swinging function is implemented via a hydromechanical mover in the form of a hydraulic motor 408 (see FIG. 3). In the meterless system illustrated, a dedicated pump 406 is provided for operation of the swing motor 408, as will be appreciated by those of skill in the art. Returning to FIG. 1, the hydraulic motor for implementing the cab swing movement may be fixed to the cab 108 and rotatably linked via a ring gear or other arrangement to the undercarriage 110. Alternately, it may be fixed to the undercarriage 110 and rotatably linked to the cab 108.

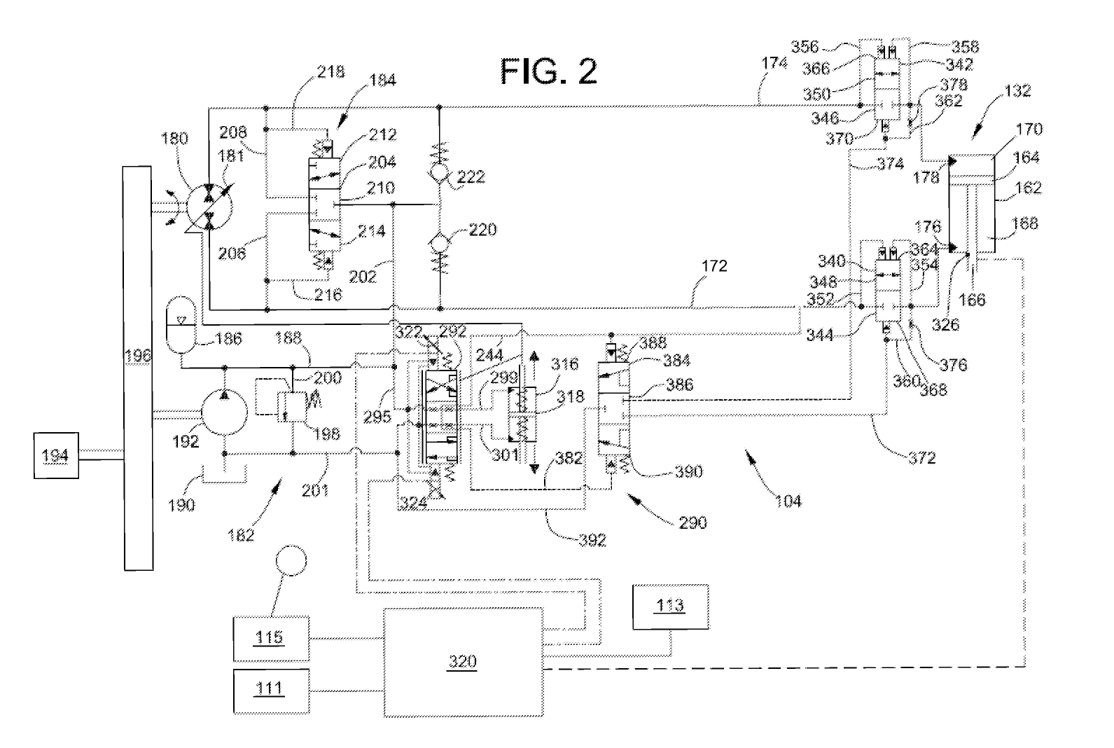

The cab 108 includes an operator station 114 from which the machine 100 may be controlled. The operator station 114 may include, for example, an operator control 115 for controlling the rotation or extension and refraction of the hydromechanical movers 102. The operator control 115 may be of any appropriate design. By way of example only, the operator control 115 may be in the form of joystick, such as illustrated in FIG. 1, a dial, a switch, a lever, a combination of the same, or any other arrangement that provides the operator with a mechanism by which to identify the movement commanded. The operator station 114 may further include controls such as a hydraulic lockout switch 113, or an on/off switch 111 as shown in FIG. 2.

The cab 108 may further include an engine 116, and at least a portion of the meterless hydraulic system 104. The engine 116 may be an internal combustion engine or any type power source known to one skilled in the art now or in the future.

A front linkage 118 includes a boom 120 that is pivotably supported on the cab 108, a stick 122 pivotably coupled to the boom 120, and an implement 124 pivotably coupled to the stick 122. While the implement 124 is illustrated as a bucket 126, the implement 124 may alternately be, for example, a compactor, a grapple, a multi-processor, thumbs, a rake, a ripper, or shears.

Movement of the boom 120, stick 122, and implement 124 is controlled by a number of hydromechanical movers 102 in the form of actuators 130, 132, 134. The boom 120 is pivotably coupled to cab 108 at one end 136. To control movement of the boom 120 relative to the cab 108, a pair of actuators 130 are provided on either side of the boom 120, coupled at one end to the cab 108, and at the other end to the boom 120.

The stick 122 is pivotably coupled to the boom 120 at a pivot connection 138. Movement of the stick 122 relative to the boom 120 is controlled by the actuator 132 that is coupled at one end to the boom 120, and at the other end to the stick 122. The actuator 132 is pivotably coupled to the stick 122 at a pivot connection 140 that is spaced from the pivot connection 138 such that extension and retraction of the actuator 132 pivots the stick 122 about pivot connection 138.

The implement 124 is pivotably coupled to the stick 122 at pivot connection 142. Movement of the implement 124 relative to the stick 122 is controlled by actuator 134. The actuator 134 is coupled to the stick 122 at one end. The other end of the actuator 134 is coupled to a four-bar linkage arrangement 144 that includes a portion of the stick 122 itself, as well as the implement 124 and a pair of links 146, 148. The actuator 134 is extended in order to move the implement 124 toward the cab (counterclockwise in the illustrated embodiment), and retracted in order to move the implement 124 away from the cab (clockwise in the illustrated embodiment).

Movement of the actuator 132 is controlled by the meterless hydraulic system 104, which is shown in greater detail in FIG. 2. While the operation of the hydraulic system 104 is explained below with regard to actuator 132, this explanation is equally applicable to the other actuators 130, 134, and other actuators operated by a similar meterless hydraulic system 104. Further, similar hydraulic supply arrangements are provided for operation of the swing motor 408.

The actuator 132 includes a cylinder 162 in which a piston 164 is slidably disposed. A rod 166 is secured to the piston 164, and extends from the cylinder 162. In this way, the piston 164 divides the interior of the cylinder 162 into a rod chamber 168 and a cap side chamber 170. In operation, as the actuator 132 is extended, hydraulic fluid flows from the rod chamber 168 and hydraulic fluid flows into the cap side chamber 170 as the piston 164 and rod 166 slide within the cylinder 162 to telescope the rod 166 outward from the actuator 132. Conversely, as the actuator 132 is retracted, hydraulic fluid flows into the rod chamber 168 and hydraulic fluid flows out of the cap side chamber 170 as the piston 164 and rod 166 slide within the cylinder 162 to retract the rod 166 into the cylinder 162. Flow of hydraulic fluid to and from the rod and cap side chambers 168, 170 proceeds through a rod side fluid connection 172 and a cap side fluid connection 174, respectively, that are fluidly coupled to respective ports 176, 178 opening in the rod or cap side chambers 168, 170 in the cylinder 162.

Flow between the rod and cap side chambers 168, 170 through the rod side and cap side fluid connections 172, 174 is provided by a pump 180 wherein the flow rate from the pump may be varied. In this way, the pump 180 controls the operation of actuator 132, rather than so-called metering valves. Any suitable pump type may be used, including without limitation, variable displacement radial pumps with reversing valve (sized for minimal losses), unidirectional axial piston pumps with a reversing valve, and so on, as well as the variable displacement type pump described below.

In the illustrated implementation, the pump 180 is a variable displacement pump 180, which includes a swash plate 181, the angle of which determines the positive or negative displacement of the pump 180, and volume of flow from the pump 180. It will thus be appreciated that the displacement of the pump 180, and, accordingly, the flow rate is controlled in order to control both the direction and volume of the flow of hydraulic fluid to provide extension and retraction of the actuator 132 as commanded by the operator. While a reversible variable displacement pump 180 is illustrated, the pump 180 may alternately be a fixed displacement pump wherein the speed may be varied by an associated driving motor. The pump 180 may operate as a pump to positively pump fluid from one fluid connection 172, 174 to the other 172, 174, or a motor as fluid flows from one fluid connection 172, 174 to the other 172, 174.

It will be appreciated by those of skill in the art that the respective volumes of hydraulic fluid flowing into and out of the rod and cap side chambers 168, 170 during extension and refraction of the actuator 132 are not equal. This is a result of the difference in surface area of the piston 164 on the rod and cap side chambers 168, 170; that is, the surface area of the piston 164 where the rod 166 extends from the piston 164 is less than the surface area of the piston 164 facing the cap side chamber 170. Consequently, during retraction of the actuator 132, more hydraulic fluid flows from the cap side chamber 170 than can be utilized in the rod chamber 168. Conversely, during extensions of the actuator 132, additional hydraulic fluid is required to supplement the hydraulic fluid flowing from the rod chamber 168 in order to fill the cap side chamber 170. To receive this excess hydraulic fluid and provide this supplemental hydraulic fluid, a charge circuit 182 and make-up hydraulic circuit 184 may be provided, as shown in FIG. 2.

The charge circuit 182 includes at least one hydraulic fluid source, two of which are provided in the illustrated embodiment. The illustrated charge circuit 182 includes an accumulator 186 that may be utilized to provide a source of pressurized hydraulic fluid or that may be charged with excess hydraulic fluid through a charge conduit 188. The illustrated charge circuit 182 additionally includes a tank 190 from which hydraulic fluid may be provided by a second pump 192 through the charge conduit 188. Excess hydraulic fluid, either from the second pump 192 or operation of the actuator 132 may be returned to either the accumulator 186, or to the tank 190 by way of a charge pilot valve 198 disposed in a charge pilot conduit 200, which is fluidly connected to return conduit 201. The charge pilot valve 198 is operated as a result of fluid pressure in the conduit 200 along the inlet side of the charge pilot valve 198, although an alternate method of operation may be provided. In this embodiment, the pump 180 and the second pump 192 are both operated by a prime mover 194, such as the engine 116, through a gearbox 196. In an alternate embodiment, one or both of the pumps 180, 192 may be connected directly to the engine 116 or prime mover 194 shaft with no speed ratio change. The pump 180 and/or the second pump 192 may alternately be operated by a battery or other power storage arrangement. It will further be appreciated that the second pump 192 may be selectively operated, or continuously operated, as in the illustrated embodiment, depending upon the arrangement provided.

The make-up hydraulic circuit 184 includes a make-up conduit 202 that is fluidly coupled to the charge conduit 188, a make-up valve 204, a rod side make-up conduit 206 and a cap side make-up conduit 208, which are fluidly coupled to the rod side fluid connection 172 and the cap side fluid connection 174, respectively. The make-up valve has three positions. The first, central default position 210 prevents flow to or from each of conduits 202, 206, 208. Alternatively, the central default position may be constructed such that conduit 208 is connected to conduit 202 by an orifice (not shown), and conduit 206 is connected to conduit 202 by an orifice (not shown); this connection using orifices may be desirable if the pump 180 does not return to a perfect zero displacement when commanded to neutral.

In order to operate the make-up valve 204, pilot connections 216, 218 are provided from the rod and cap side make-up conduits 206, 208, respectively. Thus, the make-up valve 204 is operative as a result of a minimum pressure differential between the pilot connections 216, 218. While very little flow occurs through the pilot connections 216, 218, it will be appreciated that the pressure from the rod side fluid connection 172 is applied to the pilot connection 216 by way of the rod side make-up conduit 206. Similarly, the pressure from the cap side fluid connection 174 is applied to the pilot connection 218 by way of the cap side make-up conduit 208.

The make-up circuit 184 may include check valves 220, 222 that are operative at set pressure differentials between the make-up conduit 202 and the rod side and cap side fluid connections 172, 174, respectively. It will be appreciated that the check valves 220, 222 will unseat to permit flow if the pressure within the make-up conduit 202 is sufficiently greater than the pressures in rod side and cap side fluid connections 172, 174, respectively. The check valves 220, 222 may include any device for limiting flow in a piping system to a single direction known by one skilled in the art now and in the future.

Turning now to FIG. 3, this figure is a schematic view of the control architecture 400 of the pump displacement control of FIG. 2 including data and command signaling. In particular, the illustrated control architecture 400 includes a human machine interface (HMI) 401 which allows the machine to receive operator commands and translate them into a machine operable form such as a digital or analog command or signal. Examples of the HMI 401 include without limitation the related structures of FIG. 1, namely operator control 115 for controlling the operation of the hydromechanical movers 102, which control may be in the form of a joystick, a dial, a switch, a lever, a combination of the same, or any other arrangement by which the operator may command a movement, as well as a hydraulic lockout switch 113, on/off switch 111, etc.

In addition to the HMI 401, the architecture 400 includes a controller 403 for receiving interface commands 402, 412 from the HMI 401. In the illustrated example, the first interface command 402 may be a boom movement command and the second interface command 412 may be a swing movement command.

The controller 403 may comprise one or more processors, e.g., microprocessors, for generating and transmitting control signals 404, 405 based on received data and commands. The controller 403 may operate specifically by the computerized execution of computer-readable instructions stored on a nontransitory computer-readable medium such as a RAM, ROM, PROM, EPROM, optical disk, flash drive, thumb drive, etc.

The controller 403 is operable to receive commands and data from the HMI 401 and optionally to receive actuator or element movement data, e.g., for position and/or acceleration, from machine sensors, and control pump flow for each pump on the basis of received commands and data. In the illustrated embodiment, a first command 404 and a second command 405 are output from the controller 403 to be provided to a first hydraulic pump 406 and to a second hydraulic pump 407 respectively. Each of the first hydraulic pump 406 and the second hydraulic pump 407 is configured to provide pressurized fluid at a commanded rate. The first hydraulic pump 406 is fluidly linked via hydraulic circuit 410 to supply pressurized fluid to a swing motor 408, while the second hydraulic pump 407 is fluidly linked via hydraulic circuit 411 to supply pressurized fluid to a boom hydraulic actuator 409. In an alternative embodiment, the hydraulic actuators 408, 409 are situated to power other independent machine functions requiring coordinated rate-based control.

Due to the independent nature of each hydraulic circuit, the illustrated meterless configuration is able to fully supply pressurized fluid responsive to received operator commands. Depending upon the number of functions operated at a given time, this response may differ from the response of an otherwise equivalent machine using a unitary metered circuit instead of multiple meterless circuits as noted above. As also noted above, the differing response may be disconcerting to the user who is actually accustomed to a more sluggish response when controlling certain machine movements simultaneously.

A primary context in which this difference may be noticeable to the operator is when the machine is commanded to lift the boom at a high rate of speed or acceleration, while simultaneously swinging to move the bucket to or from a pile. This movement is sometimes referred to as “coming out of the hole.” In a traditional metered system, the raising of the boom in an abrupt manner decreases the hydraulic flow to the swing motor, resulting in a variable and somewhat sluggish swing motion anytime the boom is commanded to undergo substantial upward motion.

In the illustrated system, this response is mimicked by independently electronically controlling multiple pumps in a variable manner with the control rate being established based on other simultaneously commanded movements. In a specific embodiment, the allowed rate of swing movement is constrained by a variable amount based on the rate of boom lift commanded. In further embodiment, this is accomplished by reducing the flow in the hydraulic circuit 410 associated with the swing motor 408 by a variable amount based on the simultaneously commanded rate of boom movement.

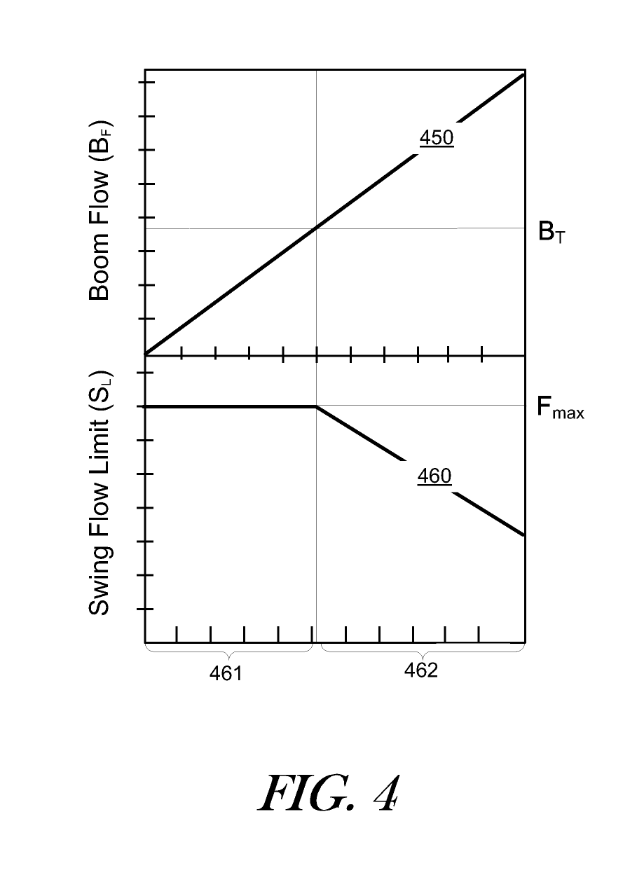

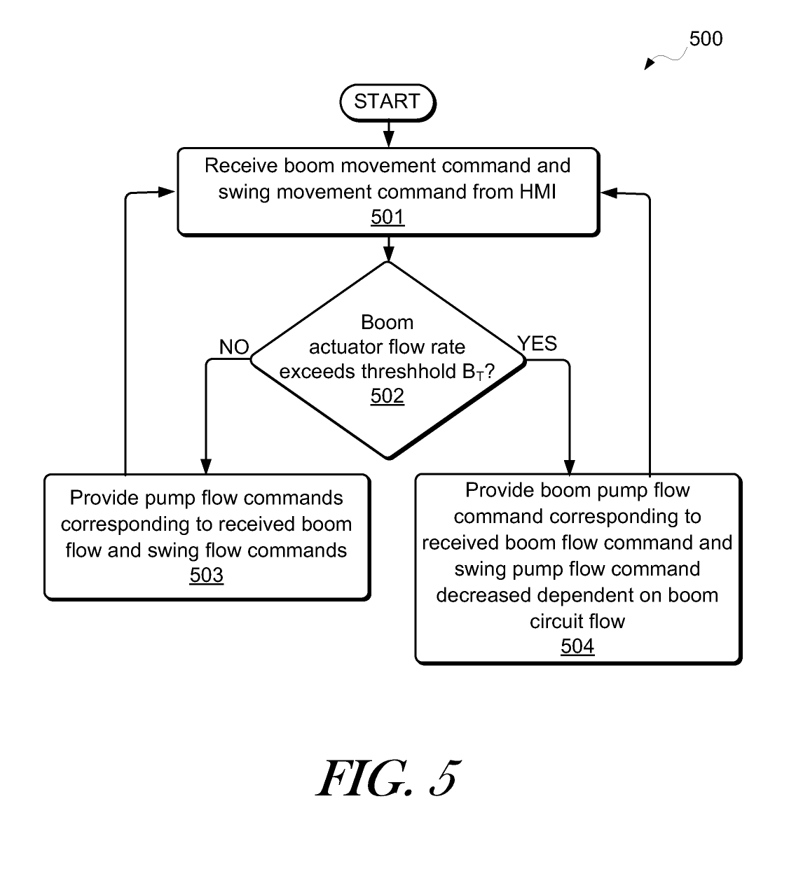

As will be discussed in greater detail hereinafter, the controller 403 implements the rate reduction scheme summarized above by reducing the swing flow command 404 by an amount dictated by any simultaneous boom lift command 405. The quantitative behavior of the system in this regard will be discussed with reference to FIG. 4, after which the operations of the controller 403 to impose swing rate limits will be discussed with reference to FIG. 5.

Turning now to FIG. 4 for the moment, this figure illustrates a set of correlated flow plots showing hydraulic circuit flow command and flow command limits for swing and boom up functions according to an embodiment of the disclosure. In particular, the boom curve 450 illustrates an increasing rate boom up user boom up command on the horizontal axis and a corresponding flow command from the controller 403 on the vertical axis. As can be seen, the issued flow command tracks the user command proportionally.

In an embodiment, this results in a swing flow limit curve as shown in plot 460. In the lower portion 461 of the swing flow limit curve, the flow available to the swing motor is unlimited except by the limit of the associated pump output Fₘₐₓ. This lower portion 461 represents the region in which the correlated instantaneous boom up flow command has not exceeded a predetermined rate Bₜ. After this point, the flow limit for the swing function changes. In particular, in region 462, the correlated instantaneous boom up flow command exceeds the predetermined rate Bₜ.

In this region, wherein the user boom command exceeds the predetermined boom rate threshold Bₜ, the swing flow limit curve is not proportional to the user swing command, but rather is decreased by a rate that is related to the contemporaneous boom flow command 450. In an embodiment, the swing motor flow limit is adjusted such that the boom flow and swing flow remain constant, mimicking the “maxing out” of a fixed flow metered system.

Thus, the swing motor flow limit S_{L} can be written in this embodiment as S_{L}=Fₘₐₓ when the boom flow B_{F} is less than B_{T}, and S_{L}=M−B_{F} when B_{F} exceeds B_{T}, where M is a maximum chosen flow rate for both the boom and swing circuits combined. In an embodiment, M=B_{T}+Fₘₐₓ. Although in a traditional metered system this would imply that there is no flow available for other hydraulic functions at such a time, in an embodiment, the flows to other actuators (other than the swing motor) in the meterless system are not affected by the flow limits imposed on the swing motor circuit.

The controller function that provides this swing flow derating behavior will be discussed in greater detail with respect to the flow chart of FIG. 5. In particular, FIG, 5 is a flow chart of a process 500 for treating swing flow commands and boom flow commands in an interdependent manner to produce a user experience that simulates that provided by a traditional metered system.

At stage 501 of process 500, the controller 403 receives a boom movement command and a swing movement command, e.g., from the HMI 401. Subsequently at stage 502, the controller 403 determines whether the received boom movement command correlates to a boom actuator flow rate exceeding the predetermined flow threshold B_{T}. If it is determined at stage 502 that the received boom movement command correlates to a boom actuator flow rate that does not exceed the predetermined boom flow threshold B_{T}, then the process 500 continues to stage 503, wherein the controller provides pump flow commands to the swing circuit pump and boom circuit pump corresponding to the received boom flow and swing flow commands. In this stage, the boom circuit flow and swing circuit flow are independent.

If, however, it is determined at stage 502 that the received boom movement command correlates to a boom actuator flow rate exceeding the predetermined flow threshold B_{T}, then the process 500 branches to stage 504 instead, wherein the controller 403 provides a pump flow command to the boom circuit pump corresponding to the received boom flow command and provides a pump flow command to the swing circuit corresponding to the received swing flow command decreased by an amount dependent on the pump flow command to the boom circuit. For example, the pump flow command to the swing circuit may be decreased to keep the sum of the boom flow and swing flow constant as discussed above. Alternatively, the pump flow command to the swing circuit may be decreased by a multiplicative factor based on the pump flow command to the boom circuit pump.

The flow commands issued to the hydraulic pumps may be digital or analog signals, and may be of any suitable type and nature. For example, in an implementation employing a variable displacement pump for each circuit, the pump flow commands may be signals adapted to drive a solenoid setting a hydraulic actuator or swashplate affecting pump displacement. In contrast, in an implementation employing fixed displacement electrically driven pumps, the pump flow commands may be electric drive signals adapted to drive the motor for each pump (or to cause the motor to be driven) at the prescribed speed to produce the desired flow rate.

### INDUSTRIAL APPLICABILITY

The described system and method may be applicable to any meterless hydraulically-actuated excavator machine having independent variable flow pumps for executing boom movement and swing movement, or more generally any machine having a meterless hydraulic system controlling multiple independent dimensions of movement. The described system allows for the benefits of meterless systems, e.g., efficiency, lowered emissions, etc., to be attained while maintaining certain desired behavior associated with metered systems wherein certain dimensions of movement (e.g., boom and swing) may interact.

In particular, in an embodiment wherein the machine is a meterless excavator, the boom and swing movements are coupled such that for low boom flows, the swing motion is unaltered but for high boom flows the swing flow is reduced to provide a coupled feel relative to the boom and swing functions. Thus, for example, when the machine is “coming out of the hole” with high boom upward acceleration, the user experiences an artificially sluggish swing response more akin to that of a metered system. This allows the user to control the meterless machine in much the same way that he or she controlled the metered machine, without encountering disconcerting changes in machine behavior and without having to change their habits of control and operation. Not only does this modification in meterless operation improve the user experience, but it also avoids the expense of retraining trained personnel to switch over from metered to meterless machines.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A machine having meterless hydraulic actuation of a plurality of functions, the machine comprising:
a first movable element, a first hydromechanical mover for moving the first movable element, and a first hydraulic pump linked to the first hydromechanical mover to supply hydraulic fluid thereto and receive hydraulic fluid therefrom;
a second movable element, a second hydromechanical mover for moving the second movable element, and a second hydraulic pump, distinct from the first hydraulic pump, linked to the second hydromechanical mover to supply hydraulic fluid thereto and receive hydraulic fluid therefrom;
a user interface for receiving movement requests for moving the first and second movable elements; and
a controller for generating movement commands to the first and second hydromechanical movers based on the received first and second movement requests, wherein the movement command to the second hydromechanical mover is reduced by a variable amount based on the magnitude of the first movement request.

2. The machine having meterless hydraulic actuation of a plurality of functions according to claim 1, wherein the machine is an excavator and the first movement command is a boom up command and the second movement command is a swing command, and the first hydromechanical mover is a hydraulic actuator and the second hydromechanical mover is a hydraulic motor.

3. The machine having meterless hydraulic actuation of a plurality of functions according to claim 1, wherein the first and second hydraulic pumps are variable displacement pumps.

4. The machine having meterless hydraulic actuation of a plurality of functions according to claim 3, wherein the first hydromechanical mover includes a piston disposed within a cylinder, and a rod extending from the piston and extending out of the cylinder, the piston defining a rod chamber and a cap side chamber within the cylinder, a rod side fluid connection between the associated hydraulic pump and the rod chamber, and a cap side fluid connection between the associated hydraulic pump and the cap side chamber.

5. The machine having meterless hydraulic actuation of a plurality of functions according to claim 4, wherein each hydraulic pump is configured to control the flow of hydraulic fluid to the associated hydromechanical mover by providing selective flow to separate portions of the hydromechanical mover.

6. The machine having meterless hydraulic actuation of a plurality of functions according to claim 1, further including at least one position sensor associated with each hydromechanical mover, the position sensor being adapted to provide a signal to the controller.

7. The machine having meterless hydraulic actuation of a plurality of functions according to claim 1, wherein the variable rate based on the magnitude and direction of the first movement request includes a first range providing substantially zero reduction to the second movement request when the first movement request is less than a predetermined threshold and a second portion providing a nonzero reduction to the second movement request when the first movement request is greater than the predetermined threshold.

8. A method of adjusting movement of movable elements in a machine having meterless hydraulic actuation of a plurality of functions, the method comprising:
receiving a first movement request for movement of a first machine element, the first machine element being actuated by a first hydromechanical mover having a first hydraulic pump linked to the first hydromechanical mover to supply hydraulic fluid thereto and receive hydraulic fluid therefrom;
receiving contemporaneously with the first movement request a second movement request for movement of a second machine element, the second machine element being movable by a second hydromechanical mover having a second hydraulic pump, distinct from the first hydraulic pump, to supply hydraulic fluid thereto and receive hydraulic fluid therefrom; and
generating movement commands to the first and second hydromechanical movers based on the received first and second movement requests, wherein generating the second movement command includes applying to the second request a variable rate based on the magnitude of the first movement request.

9. The method of adjusting movement of movable elements in a machine having meterless hydraulic actuation of a plurality of functions according to claim 8, wherein the machine is an excavator and the first movement command is a boom up command and the second movement command is a swing command, and the first hydromechanical mover is a hydraulic actuator and the second hydromechanical mover is a hydraulic motor.

10. The method of adjusting movement of movable elements in a machine having meterless hydraulic actuation of a plurality of functions according to claim 8, wherein the first and second hydraulic pumps are variable displacement pumps.

11. The method of adjusting movement of movable elements in a machine having meterless hydraulic actuation of a plurality of functions according to claim 8, wherein at least one hydromechanical mover includes a piston disposed within a cylinder, and a rod extending from the piston and extending out of the cylinder, the piston defining a rod chamber and a cap side chamber within the cylinder, a rod side fluid connection between the associated hydraulic pump and the rod chamber, and a cap side fluid connection between the associated hydraulic pump and the cap side chamber.

12. The method of adjusting movement of movable elements in a machine having meterless hydraulic actuation of a plurality of functions according to claim 11, wherein each hydraulic pump is configured to control the flow of hydraulic fluid to the associated hydromechanical mover by providing selective flow between different portions of the hydromechanical mover.

13. The method of adjusting movement of movable elements in a machine having meterless hydraulic actuation of a plurality of functions according to claim 8, wherein applying to the second request a variable rate based on the magnitude and direction of the first movement request includes providing substantially zero reduction to the second movement request when the first movement request is less than a predetermined threshold and providing a nonzero reduction to the second movement request when the first movement request is greater than the predetermined threshold.

14. A controller for controlling first and second hydromechanical movers linked to first and second movable elements in a machine, each hydromechanical mover having a separate respective hydraulic pump for supplying pressurized hydraulic fluid to, and receiving pressurized hydraulic fluid from, the hydromechanical mover, the controller including a computer-readable memory having thereon computer-executable instructions including:
instructions for receiving a first movement request for movement of the first movable element;
instructions for receiving contemporaneously with the first movement request a second movement request for movement of the second movable element; and
instructions for generating movement commands to the first and second hydromechanical mover based on the received first and second movement requests, wherein generating the second movement command includes applying to the second request a variable rate based on the magnitude and direction of the first movement request.

15. The controller according to claim 14, wherein the machine is an excavator and the first movement command is a boom up command, the second movement command is a swing command, the first hydromechanical mover comprises a hydraulic actuator and the second hydromechanical mover comprises a hydraulic motor.

16. The method controller according to claim 14, wherein the first and second hydraulic pumps are variable displacement pumps.

17. The controller according to claim 14, wherein at least one hydromechanical mover includes a piston disposed within a cylinder, and a rod extending from the piston and extending out of the cylinder, the piston defining a rod chamber and a cap side chamber within the cylinder, a rod side fluid connection between the associated hydraulic pump and the rod chamber, and a cap side fluid connection between the associated hydraulic pump and the cap side chamber.

18. The controller according to claim 17, wherein the movement commands to the first and second hydromechanical movers comprise respective commands to the first and second hydraulic pumps to control the flow of hydraulic fluid to the associated hydromechanical mover.

19. The controller according to claim 14, wherein the instructions for applying to the second request a variable rate based on the magnitude and direction of the first movement request include:
instructions for providing substantially zero reduction to the second movement request when the first movement request is less than a predetermined threshold; and
instructions for providing a nonzero reduction to the second movement request when the first movement request is greater than the predetermined threshold.

20. The controller according to claim 14, wherein the instructions for receiving a first movement request and for receiving a second movement request include instructions for receiving input from an operator interface.
